(19) United States
(12) Patent Application Publication
(10) Pub. No.: US 2018/0164119 A1
(43) Pub. Date: Jun. 14, 2018

(54) SYSTEM AND METHOD FOR GENERATING AN ENVIRONMENTAL CONDITION DATABASE USING AUTOMOTIVE SENSORS

(71) Applicant: Faraday&Future Inc., Gardena, CA (US)

(72) Inventor: Jan Becker, Palo Alto, CA (US)

(21) Appl. No.: 15/662,632

(22) Filed: Jul. 28, 2017

Related U.S. Application Data
(60) Provisional application No. 62/368,910, filed on Jul. 29, 2016.

(51) Int. Cl. G01C 21/36; G01W 1/06; B60W 40/02

(52) U.S. Cl. CPC G01C 21/3691; G01W 1/06; B60W 2550/12; G01C 21/367; B60W 40/02

(57) ABSTRACT

Examples of the disclosure are directed to generating real-time weather maps using automotive sensors.

### CROSS-REFERENCE TO RELATED APPLICATIONS

This application claims the benefit of U.S. Provisional Application No. 62/368,910, filed Jul. 29, 2016, the entirety of which is hereby incorporated by reference.

### FIELD OF THE DISCLOSURE

This relates generally to sensing one or more environmental conditions associated with a vehicle's surroundings, and more particularly, to generating a real time map of environmental conditions using one or more vehicle sensors.

### BACKGROUND OF THE DISCLOSURE

Vehicles, especially automobiles, increasingly include various sensors for detecting and gathering information about the vehicles' surroundings. For example, vehicles can include temperature sensors and/or rain sensors. However, existing weather-related data for generating a weather map is typically collected by a dedicated weather station at a fixed location.

### SUMMARY OF THE DISCLOSURE

Examples of the disclosure are directed to weather databases and/or maps of various environmental conditions that are populated based on data collected by one or more vehicle sensors that are otherwise used to facilitate normal vehicle operation. A vehicle may serve as a rolling weather station, where the vehicle's sensors can collect data regarding one or more environmental conditions, such as ambient temperature data, precipitation data, barometric data, characteristics about roads on which the vehicle is traveling, among other conditions. The vehicle may report collected data regarding environmental conditions to other vehicles and/or upload it to a server. In this way, the vehicle can obtain and report up to date information about the weather and driving conditions, generally, at its location when desired, and can reduce delays, costs, and computing power requirements for determining weather data and/or environmental conditions.

### BRIEF DESCRIPTION OF THE DRAWINGS

FIG. 1 illustrates an exemplary system block diagram of a vehicle control system according to examples of the disclosure.

FIG. 2 illustrates an exemplary vehicle and several environmental conditions according to examples of the disclosure.

FIG. 3 illustrates an exemplary real-time weather map according to examples of the disclosure.

FIG. 4 illustrates an exemplary process for determining environmental conditions at a vehicle's location according to examples of the disclosure.

FIG. 5 illustrates another exemplary process for determining environmental conditions at a vehicle's location according to examples of the disclosure.

FIG. 6 illustrates an exemplary process for determining a vehicle's location according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples. Further, in the context of this disclosure, “autonomous driving” (or the like) can refer to either autonomous driving, partially autonomous driving, and/or driver assistance systems.

Some vehicles, such as automobiles, may include various sensors for detecting and gathering information about the vehicles' surroundings. The various sensors may be configured to gather a wide variety of information. The information gathered by a vehicle's sensors may be used by the vehicle to determine an environmental condition, or may be communicated to another device (e.g., a server) in communication with the vehicle.

Vehicles, especially automobiles, increasingly include various sensors for detecting and gathering information about the vehicles' surroundings. For example, vehicles can include temperature sensors and/or rain sensors. However, existing weather-related data for generating a weather map is typically collected by a dedicated weather station at a fixed location. Examples of the disclosure are directed to weather databases and/or maps of various environmental conditions that are populated based on data collected by one or more vehicle sensors. A vehicle may serve as a rolling weather station, where the vehicle's sensors can collect data regarding one or more environmental conditions, such as ambient temperature data, precipitation data, barometric data, characteristics about roads on which the vehicle is traveling, among other conditions. The vehicle may report collected data regarding environmental conditions to other vehicles and/or upload it to a server. In this way, the vehicle can obtain and report up to date information about the weather and driving conditions, generally, at its location when desired, and can reduce delays, costs, and computing power requirements for determining weather data and/or environmental conditions.

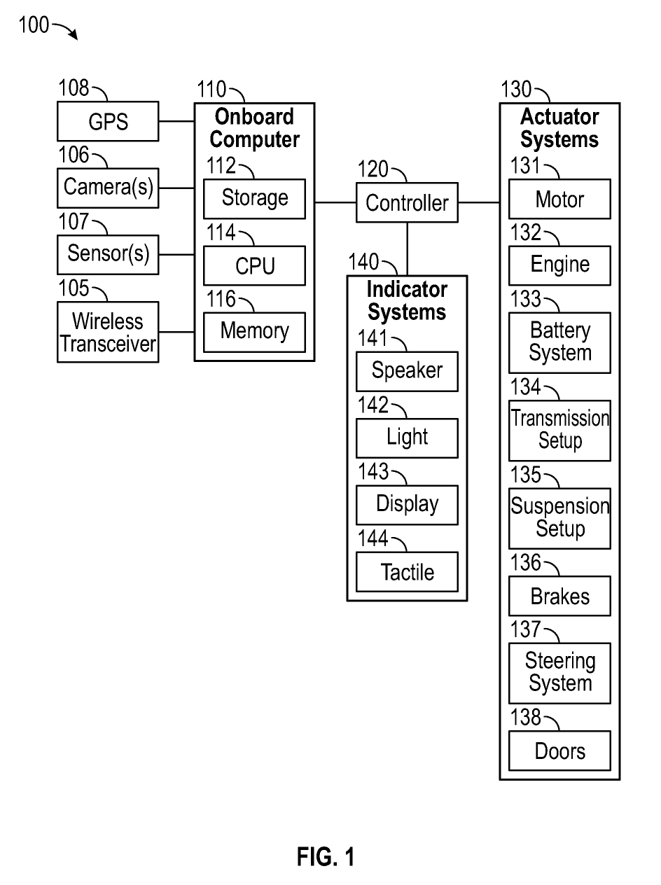

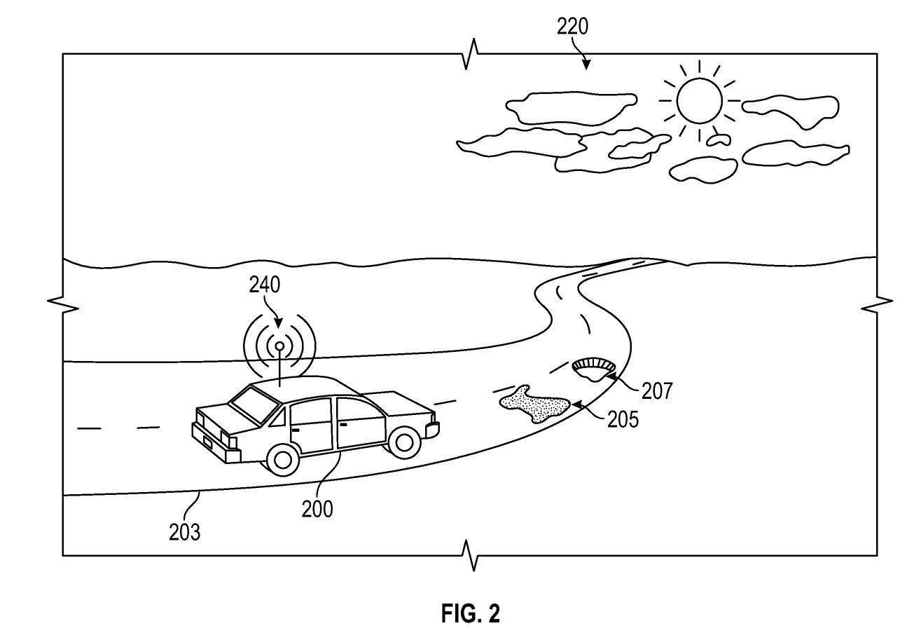

FIG. 1 illustrates an exemplary system block diagram of a vehicle control system according to examples of the disclosure. Vehicle control system 100 can perform any of the methods described with reference to FIGS. 2-6. System 100 can be incorporated into a vehicle, such as a consumer automobile. Other example vehicles that may incorporate the system 100 include, without limitation, airplanes, boats, motorcycles, or industrial automobiles.

Vehicle control system 100 can include a wireless transceiver 105 capable of enabling communication between the vehicle control system 100 and another control system or computing device. In some examples, a vehicle control system 100 may use the wireless transceiver 105 to access and/or update a weather map stored on a network or server. The control system 100 may also include one or more cameras 106 capable of capturing image data (e.g., video data) for determining various characteristics of the vehicle's surroundings. Cameras 106 can include, but are not limited to, forward looking camera(s) located on the front of the vehicle, surround view camera(s) located along the proximity of the vehicle, and rear view camera(s) located on the rear of the vehicle.

Vehicle control system 100 can also include one or more other sensors 107 (e.g., ambient temperature sensors, rain sensors, barometric pressure sensors, humidity sensors, microphone, radar, ultrasonic, LIDAR, among others) capable of detecting various characteristics or environmental conditions of the vehicle's surroundings. For example, sensors 107 can be used for detecting various kinds of data based on the vehicle's surroundings (e.g., various kinds of weather data). As another example, sensors 107 can be used to assist with electronic vehicle stability control. For example, sensors 107 that measure yaw rate, wheel speed and acceleration can provide data used to determine whether one or more wheels of a vehicle start to slip. From a slip in combination with a temperature that is near or below freezing, a determination of ice on the road can be made. Similarly, a slip in combination with rain can be used to determine that a vehicle is hydroplaning. Global Positioning System (GPS) receiver 108 can be capable of determining the location and/or position of the vehicle. Location information and information associated with electronic vehicle stability control, ice, and/or hydroplaning can be transmitted to other vehicles or a server (e.g., a cloud system) for alerts and/or analysis.

Vehicle control system 100 can include an on-board computer 110 that is coupled to the cameras 106, sensors 107, and GPS receiver 108, and that is capable of receiving the image data from the cameras 106 and/or outputs from the sensors 107 and the GPS receiver 108. The on-board computer 110 can be capable of controlling operation of the vehicle as described in this disclosure. On-board computer 110 can include storage 112, memory 116, and a processor (CPU) 114. CPU 114 can perform any of the methods described in this disclosure, including those described with reference to FIGS. 2-6. Additionally, storage 112 and/or memory 116 can store data and instructions (such as instructions for) for performing any of the methods described in this disclosure, including those described with reference to FIGS. 2-6. Storage 112 and/or memory 116 can be any non-transitory computer readable storage medium, such as a solid-state drive or a hard disk drive, among other possibilities. The vehicle control system 100 can also include a controller 120 capable of controlling one or more aspects of vehicle operation, such as providing an indication to a driver based on the determinations of the on-board computer 110. In some examples, the vehicle control system 100 can be connected to (e.g., via controller 120) one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137 and door system 138. The vehicle control system 100 can control, via controller 120, one or more of these actuator systems 130 during vehicle operation; for example, to open or close one or more of the doors of the vehicle using the door actuator system 138, to control the vehicle during autonomous driving or parking operations, using the motor 131 or engine 132, battery system 133, transmission gearing 134, suspension setup 135, brakes 136 and/or steering system 137, etc. The one or more indicator systems 140 can include, but are not limited to, one or more speakers 141 in the vehicle (e.g., as part of an entertainment system in the vehicle), one or more lights 142 in the vehicle, one or more displays 143 in the vehicle (e.g., as part of a control or entertainment system in the vehicle) and one or more tactile actuators 144 in the vehicle (e.g., as part of a steering wheel or seat in the vehicle). The vehicle control system 100 can control, via controller 120, one or more of these indicator systems 140 to provide indications to a driver of the vehicle of weather characteristics in the vehicle's surroundings determined by the on-board computer 110.

FIG. 2 illustrates an exemplary vehicle 200 on a road 203 and several environmental conditions according to examples of the disclosure. The vehicle 200 may be equipped with various sensors (e.g., automotive sensors) that are normally configured to facilitate one or more functions of the vehicle (e.g., sensors for performing traction control functions when the vehicle's tires lose traction, sensors for automatically turning on/off windshield wipers when it is raining, etc.). In some examples, the various sensors of the vehicle 200 may be pre-existing sensors of the vehicle 200. The various sensors may be used to gather data based on the vehicle's surroundings or to detect one or more environmental conditions. In some examples, the vehicle 200 may include one or more ambient temperature sensors to detect an ambient temperature at or near the vehicle 200. In some examples, the vehicle 200 may include one or more cameras, or other imaging sensors, configured to detect a cloudy sky 220. More specifically, in some examples, the various sensors of vehicle 200 may be used as sensors to enable or facilitate various functions of the vehicle (e.g., stability control to control wheel slippage, rain sensors to control automatic windshield wipers, a camera for viewing behind the vehicle while backing up and/or performing automated driving operations, among other functions). For example, the vehicle 200 may drive along the road 203 while using its various sensors and/or cameras in their normal driving modes, and may encounter a pothole 207 in the road 203, which one or more suspension sensors of the vehicle 200 may detect. Then, the vehicle 200 may use data output by the one or more suspension sensors to determine that an environmental condition (e.g., the pothole 207) exists at the location where the vehicle 200 encountered the pothole 207. As another example, the vehicle 200 may drive along the road 203 while using its various sensors and/or cameras in their normal drive configurations to facilitate the vehicle's autonomous driving operations. The vehicle 200 may then encounter a patch of ice that is detected by the vehicle's sensors. More specifically, the vehicle 200 may determine that it has encountered the ice patch using data from its stability control and ambient temperature sensors. Thus, the vehicle 200 may determine that the patch of ice exists at the location indicated by the data (e.g., the decreased traction and ambient temperature below a specified freezing temperature). In some embodiments, a vehicle may differentiate between ice that a camera can detect and ice that a camera cannot detect (e.g., “black ice”), and perform actions based on the type of ice (e.g., provide an alert to other vehicles indicating that the ice may not be detected by a camera).

As an additional example, as described above, the vehicle 200 may include electronic stability control sensors that may detect when one or more wheels on the vehicle 200 slip, which can indicate that the vehicle 200 has come into contact with a slick portion 205 of the road 203 such as a patch of ice. The vehicle 200 may determine that a detected slick portion 205 of the road 203 is oil or the like rather than ice, based on one or more inputs indicating that ice is unlikely to exist on the road 203 (e.g., input from an ambient temperature sensor indicating that the ambient temperature is above a freezing temperature point). The vehicle 200 may include suspension sensors to collect data indicative of the condition or quality of the driving surface of the road 203. Vehicle 200 may be equipped with sensors to detect variations in the driving surface of the road 203.

The vehicle 200 may include a means of wireless communication 240 to communicate a determined environmental condition to a remote database or a remote server. Additionally or alternatively, the vehicle 200 may communicate one or more environmental conditions to another vehicle, a smartphone, tablet computer, or any other suitable electronic device. The vehicle 200 may communicate an environmental condition along with a location associated with the environmental condition. Alternatively, the vehicle 200 may simply communicate an environmental condition without communicating a location associated with the environmental condition. In some examples, one or more weather conditions can be used to populate a map of environmental conditions (e.g., a weather map). For example, a weather map can be a collection of environmental conditions organized by location, and that are determined according to data collected and communicated by multiple vehicles. More specifically, the weather map can include sufficient data points (e.g., environmental conditions), communicated from multiple vehicles, so that the weather map, (e.g., one or more environmental conditions of the weather map) can be updated and/or populated in real time. In some examples, a weather map may be populated in real time based on real time data communicated by several vehicles at a variety of locations. Further, in some examples, the weather map can be stored on a server or database in wireless communication with several vehicles and the weather map may be accessed by any of the various vehicles in wireless communication with the server where the weather map is stored.

In some examples, a vehicle's operation may be based on, or according to, a weather map. In particular, the vehicle may plan or select a route, determine a driving style or driving mode (e.g., level of caution), and the like, based on the various environmental conditions indicated by a weather map. For example, where a weather map indicates heavy rain at a point along a vehicle's determined route, the vehicle may respond by transitioning to a particular driving style, based on the indication of heavy rain. More specifically, the vehicle may transition to a more conservative driving style, or to a heavy rain driving style, that may, for example, include increasing a following distance of the vehicle to account for a likely decrease in traction. As another example, a vehicle may access a weather map and determine that snow is associated with a point along a particular route, and may avoid the route based on a determination that the vehicle cannot safely operate in the amount of snow indicated by the weather map.

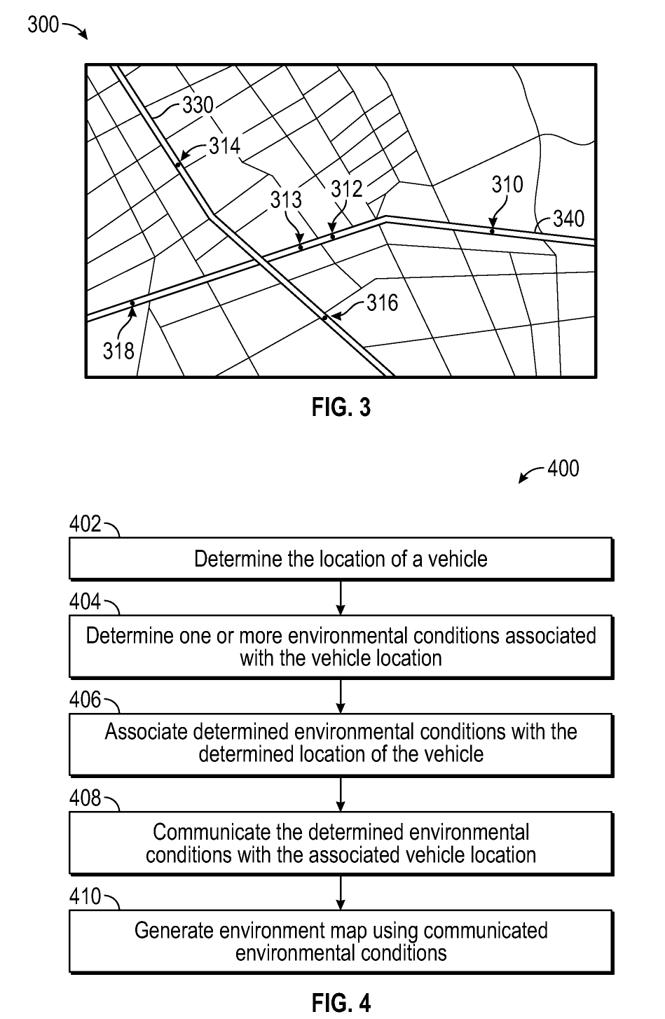

FIG. 3 illustrates an exemplary weather map 300 according to examples of the disclosure. The weather map 300 includes, without limitation, two freeways 330 and 340, and a plurality of locations along the freeways 330, 340 which may be associated with one or more environmental conditions determined by one or more vehicles, as described in this disclosure. As described herein, an environmental condition may include any suitable weather characteristic or any characteristic of a vehicle's surroundings.

As previously described, a vehicle may collect information or data indicative of an environmental condition at the location of the vehicle using various sensors. The sensors may be automotive sensors, or sensors typically used to collect information regarding the vehicle or to facilitate operation of the vehicle. The vehicle may communicate collected data to a server or a database in communication with the vehicle to create and/or populate a weather map, as shown in FIG. 3.

Alternatively or in addition, a location of the vehicle may be determined as a region, a portion of a road or of a freeway 330, 340, and/or any suitable location to associate with an environmental (e.g., weather) condition. For example, various vehicles may detect an ambient temperature of 36 degrees Fahrenheit and light rain at location 310 from their ambient temperature and rain sensors. The vehicles may determine and/or communicate data indicating that a 36 degree ambient temperature and rain were detected near location 310 on freeway 340. In response, a weather map may automatically populate and/or update location 310 with the communicated environmental conditions (e.g., ambient temperature of 36 degrees and rain). In some examples, the weather map may populate and/or update a location (e.g., location 310) with a weather condition indicated by an average value of the aggregate data communicated by every vehicle at that same location (e.g., location 310). As another example, one or more vehicles may similarly detect and communicate an ambient temperature of 30 degrees Fahrenheit and snow at location 312 that may correspond to a specific lane position on one side of the freeway 340. As yet another example, several vehicles may detect and communicate an ambient temperature of 28 degrees Fahrenheit, heavy snowfall, and icy road conditions may be associated with location 318. In some examples, a pothole may be detected at, and subsequently associated with, location 313 at a lane position on freeway 340, different from the lane position of location 312. As an additional example, multiple vehicles may detect and communicate data indicating hail at location 314 and at location 316 of freeway 330, and the corresponding locations of a weather map may be automatically updated based on the communicated data. In some examples, each location of a weather map may be automatically updated over time; that is, a location may be updated every time new data collected at that location is communicated from a vehicle. Stated differently, the weather map may be updated in real-time based on location and environmental condition information determined and communicated by the vehicles.

In some examples, the weather map may be accessible to all vehicles in communication with a server or database where the weather map is stored. Thus, a vehicle that collects and communicates data indicative of an environmental condition, or a weather condition, may access a weather map based on similar data collected and communicated by many vehicles. In particular, the aggregated data collected by multiple vehicles may form a portion of the weather map, and may be accessible to all of the vehicles that are in communication with the server or database where the aggregate data is received or stored. In some examples, a vehicle may access a weather map, or aggregate data collected by multiple vehicles, for use in operation of any of the vehicles individually. For example, a vehicle may access a weather map stored on a server to determine a route of the vehicle based on weather preferences of the vehicle's passengers. As another example, a vehicle may access a weather map in order to anticipate or predict changes in vehicle traffic based on the weather map.

FIG. 4 illustrates an exemplary process 400 for generating a map of environmental conditions according to examples of the disclosure. Process 400 can be performed continuously or repeatedly by the vehicle whenever information about the vehicle's surroundings is needed or whenever a change is detected in one or more environmental conditions associated with the vehicle's location. Alternatively or in addition, process 400 can be performed continuously or repeatedly by the vehicle whenever the vehicle travels a certain distance or at determined intervals of time.

At block 402, in some examples, a location of a vehicle may be determined. In some examples, the vehicle location may be determined using a GPS receiver of the vehicle. Alternatively or in addition, a location of the vehicle may be determined using a GPS receiver of an electronic device in communication with the vehicle (e.g., a docked smartphone). A location of the vehicle may be determined based on a previous location of the vehicle and known travel information. For example, a location of the vehicle may be determined based on one or more of a previous vehicle location, a travel time, an average travel velocity, and an average travel direction associated with the vehicle. In some examples, a location of the vehicle may be determined based on communication with one or more additional vehicles.

In some examples, a location of the vehicle may be determined in response to a command from an onboard computer of the vehicle. Alternatively or in addition, the vehicle's location may be determined in response to a request to determine a location of the vehicle, the request sent from a server or a database in communication with the vehicle.

Alternatively, or in addition, some examples may determine a location of the vehicle without regard to when an environmental condition is determined. For example, a vehicle location may be determined after a vehicle collects data but prior to a determination of an environmental condition. In another example, a vehicle location may be determined, data may be collected, and/or an environmental condition may be determined simultaneously and/or at substantially the same time. In some examples, a location may be determined some set amount of time after data is collected or after an environmental condition is determined.

A location of the vehicle may be determined according to any of the above criteria according to any suitable logic or configuration. For example, a vehicle location may be determined periodically at a set interval of time. In some examples, a vehicle location may be determined each time the vehicle travels a certain distance (e.g., every 5 miles, 10 miles, 20 miles, 50 miles, or 100 miles, etc.). In other examples, a vehicle location may be determined every time an environmental condition is determined. In still other examples, a vehicle location may be determined without regard to whether an environmental condition is determined, or may be determined after more than one environmental condition is determined.

At block 404, in some examples, one or more environmental conditions associated with the location of the vehicle may be determined. In particular, determining an environmental condition may include collecting data regarding the surroundings of the vehicle using various automotive sensors that are also used to collect data facilitating one or more functions of the vehicle (e.g., traction sensors, temperature sensors, etc.). For example, the vehicle may receive data from its various automotive sensors in their normal driving configurations, and may determine that it has encountered an environmental condition (e.g., a patch of ice) based on the data output by the various automotive sensors (e.g., data indicating a sudden loss of traction) in their normal driving configurations. The data collected by the vehicle using its various sensors in their normal driving configurations, and/or the environmental condition determined by the vehicle based on the collected data, may be communicated to a server or a database that is in communication with the vehicle (e.g., via wireless transceiver 105).

In some examples, a database or a server may determine an environmental condition based on data that is collected by one or more vehicles. In some examples, the vehicle may determine an environmental condition based on collected data and may communicate the determined environmental condition to the server in communication with the vehicle.

The vehicle may store collected data, determined environmental conditions, and/or determined locations corresponding to collected data, a determined environmental condition, and/or a route or trip. The vehicle may determine one or more environmental conditions after the route or trip is completed. In some examples, the vehicle may communicate stored data and/or determined locations after a trip is completed.

An environmental condition may be determined according to a function characterizing collected data, according to a threshold evaluation of the data, and/or according to one or more probabilistic evaluations of the data collected by the vehicle. In some examples, an environmental condition may be determined by comparing collected data with a threshold or a function representing the environmental condition being determined. For example, an icy road condition may be determined based on data indicating an ambient temperature lower than, or sufficiently near 32 degrees Fahrenheit, information regarding wind speed, location information (e.g., whether a vehicle is located on a bridge), and/or based on data from traction control sensors indicating the vehicle's wheel slippage is more than a threshold amount in less than a threshold amount of time.

At block 406, in some examples, the determined environmental conditions may be associated with the location of the vehicle determined at 402. For example, a vehicle, or a vehicle's onboard computer, may associate a determined environmental condition with a determined location, and may communicate both to a server or database in communication with the vehicle. For example, at 408, the determined environmental condition with the associated vehicle location may be communicated.

At block 410, in some examples, the communicated environmental condition and the associated vehicle location may be used to generate a map of environmental conditions. In some examples, the map of environmental conditions may be configured as a weather map. The map of environmental conditions generated at 410 may be updated in real-time. For example, the map of environmental conditions may be configured as a real-time weather map, and may be generated based on collected data and/or environmental conditions reported by at least one vehicle.

The map of environmental conditions may also be based on aggregate data or aggregate environmental conditions communicated and/or determined by a plurality of vehicles. For example, the map of environmental conditions may use a plurality of environmental conditions reported by several different vehicles all at a single location to determine what environmental condition to include at the location as part of the map of environmental conditions. In some examples, data may be collected and communicated by different vehicles, and the communicated data can be used to determine or indicate different environmental conditions at different locations (e.g., the different locations of each vehicle).

In some examples, the map of environmental conditions may be used to predict future environmental conditions and/or generate a map of environmental conditions likely to occur at a future time. For example, a history of environmental conditions determined at a single location over a suitable period of time (e.g., days, weeks, months, and/or years) may be used to assign a probability of specific environmental conditions occurring at that location in the future. In some examples, a vehicle may use a map of environmental conditions to determine a route of the vehicle. In particular, a vehicle may use a weather map to determine that a portion of a route includes adverse weather (e.g., rain, snow, hail, ice, among others) and may avoid the route and may choose another route based on the weather map indicating that no portion of that route adverse weather.

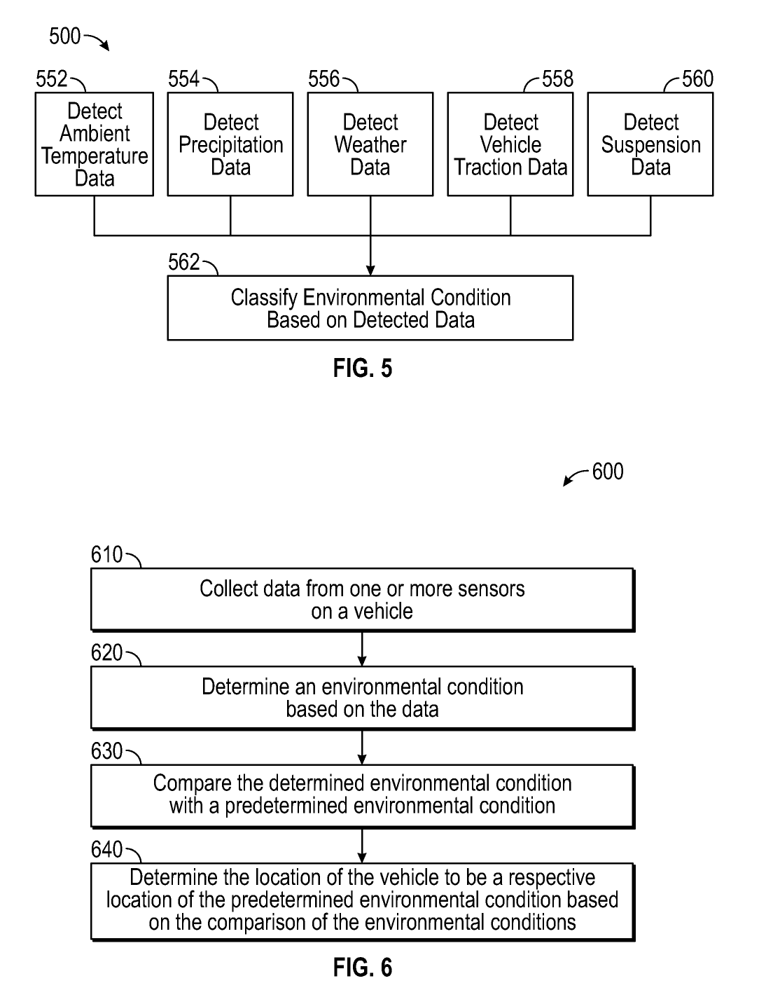

FIG. 5 illustrates another exemplary process 500 for collecting environmental condition data according to examples of the disclosure. Process 500 can be performed continuously or repeatedly by the vehicle whenever information about the vehicle's surroundings is needed or whenever a change is detected in one or more environmental conditions associated with the vehicle's location. Alternatively or in addition, process 500 can be performed continuously or repeatedly by the vehicle whenever the vehicle travels a certain distance or at determined intervals of time.

Process 500 may be included as method of determining an environmental condition as described at step 404 of process 400. According to the examples described herein, the following steps (e.g., blocks 552-560) provide examples of the various kinds of data a vehicle may collect using various sensors (e.g., suspension sensors, stability control sensors, temperature sensors, etc.) to determine one or more environmental conditions of the vehicle's surroundings.

At block 552, in some examples, the vehicle may collect data indicating an ambient temperature at the location of the vehicle. Stated differently, the vehicle may detect an ambient temperature of its surroundings using one or more temperature sensors. For example, the vehicle may be equipped with one or more ambient temperature sensors (e.g., thermostats) that may be normally configured to facilitate one or more vehicle functions (e.g., automatic operation of an interior climate control system of the vehicle), that the vehicle may also use to collect data to determine an ambient temperature (as an environmental condition) at a location of the vehicle.

At block 554, in some examples, the vehicle may collect data indicating precipitation (e.g., rain) at the vehicle's surroundings. For example, the vehicle may be equipped with one or more precipitation sensors that are normally configured to detect when rain, snow, sleet, or hail is falling and to allow the vehicle to respond with appropriate action (e.g., automatically engage windshield wipers, activate 4-wheel drive, etc.). The vehicle's precipitation sensors may also be used to collect data to determine an environmental condition, such as rain.

At block 556, in some examples, the vehicle can additionally include extra sensors that may collect data indicating weather conditions, or may be configured to collect further weather data at the vehicle. For example, a vehicle may be equipped with one or more cameras (e.g., a backup camera, a lane-changing camera, etc.) that are normally configured to increase a driver's visibility of the vehicle's surroundings, or to provide image data for autonomous vehicle operations, and that the vehicle may use to collect data (e.g., weather data) indicating the presence and type of clouds visible at the vehicle's location. In some examples, the one or more vehicle cameras may collect data (capture an image of the vehicle's surroundings) allowing a determination that an environmental condition (e.g., dark cloud cover) is visible at the vehicle's location. The vehicle may include an onboard computer configured to characterize data collected via the one or more cameras. In some examples, the weather data may be the raw image captured by one or more cameras of the vehicle. As another example, the vehicle may be equipped with one or more barometric pressure sensors that are normally configured to facilitate one or more vehicle functions (e.g., automatic operation of the vehicle's interior climate control system). The vehicle may use the one or more barometric pressure sensors to collect data that may be used to determine a barometric pressure at the vehicle's location.

In some examples, the vehicle may be equipped with one or more humidity sensors that are normally configured to facilitate one or more functions of the vehicle (e.g., automatic operation of the vehicle's interior climate control system). In some examples, the vehicle may use the one or more humidity sensors to collect weather data indicating humidity at the vehicle's location. As still another example, the vehicle may be equipped with one or more microphones normally used by the vehicle to facilitate one or more vehicle functions (e.g., noise cancellation, vehicle diagnostics, etc.). The vehicle may use the one or more microphones to collect data (e.g., recorded sound) to determine an environmental condition at the vehicle's location (e.g., hail). For example, the vehicle may use the microphones to collect data indicating hail as an environmental condition at the vehicle's location based on the data collected by the vehicle's microphones. In some examples, the vehicle may be equipped with one or more incline sensors to facilitate one or more vehicle functions (e.g., automatic engine adjustment based on incline). The vehicle may use the one or more incline sensors to collect data to determine an incline of the vehicle. For example, the vehicle may collect data using the incline sensors to determine that the vehicle is inclined upwards at a thirty degree angle.

At block 558, in some examples, the vehicle may collect data from stability control sensors indicating whether any sudden slippage of the vehicle's tires has occurred (e.g., traction data). For example, the vehicle may be equipped with an Electronic Stability Control or Electronic Stability Program (ESP) to improve vehicle stability. The vehicle's ESP may include one or more stability control system sensors or traction sensors to determine whether the vehicle has lost traction and to cause the ESP to operate to increase the traction of the vehicle (e.g., operate to end or reduce a skidding condition of the vehicle). The one or more stability control sensors or traction sensors of the vehicle's ESP may collect data to determine an environmental condition (e.g., icy road), rather than merely collect data to allow the ESP to increase traction, according to any suitable criteria. For example, the traction sensors may be configured to collect data in a continuous fashion. In some examples, the traction sensors may be configured to collect traction data periodically. In some examples, the traction sensors may be configured to collect data for determining an environmental condition in response to a determination that the vehicle has lost substantial traction, or that a substantial change in the vehicle traction has occurred.

The data from the stability control sensors may indicate, or be used to determine, an environmental condition capable of substantially reducing the vehicle's traction or causing a sudden slippage. Data from the stability control sensors may be used in conjunction with other forms of collected data to determine an environmental condition. For example, where data from the stability control sensors indicates a sufficient decrease of traction within a sufficiently short period of time (e.g., a sudden skid), a temperature (e.g., a temperature below a specified value, such as 32 degrees Fahrenheit) may enable a determination that the low traction is likely caused by ice or snowfall. In other examples, data indicating an ambient temperature above a specified value (e.g., 32 degrees Fahrenheit) may be used with data from the stability control sensors indicating a sudden decrease in traction to determine that the slippage is likely caused by an oil slick, rain, or other suitable condition where the temperature makes snow or ice accumulation unlikely.

At block 560, in some examples, the vehicle may be equipped with various suspension sensors that are normally configured to facilitate one or more vehicle functions (e.g., automatically adjust engine operation based on the vehicle's suspension). The vehicle may collect data from the suspension sensors indicating, or to determine, a road quality, or a road condition. For example, the vehicle may be equipped with one or more suspension sensors that may normally operate to adjust the vehicle's operation based on the load on the vehicle's suspension, and may use data from the suspension sensors to determine that substantial variations in the surface of a road (e.g., potholes, ditches, ruts, etc.) exist at the vehicle's location. In some examples, the vehicle may continuously collect data from the suspension sensors to determine a road condition at the vehicle's location. In some examples, the vehicle may periodically collect data to determine a road condition at the vehicle's location. In some examples, the vehicle may collect data to determine a road condition in response to a request for such data collected at the vehicle's location.

At block 562, in some examples, an environmental condition may be determined and/or classified based on one or more sets of collected data. An environmental condition may be determined by any suitable device, or any suitable device may receive and characterize data as one or more environmental conditions. For example, a vehicle or an onboard computer of the vehicle may receive and/or collect data and may determine one or more environmental conditions based on the received/collected data. In some examples, a server may be in communication with a vehicle that collects and communicates collected data to the server. According to the communicated data, the server may determine one or more environmental conditions associated with the data collected and/or communicated by the vehicle. One or more environmental conditions may be determined based on the output of an individual sensor or based on the output of a single type of sensor. For example, an environmental condition such as temperature may be determined solely based on ambient temperature data reported from one or more ambient temperature sensors.

In some examples, one or more environmental conditions may be determined based on the outputs of a plurality of sensors or based on the outputs of several different types of sensors. For example, an environmental condition such as an icy road may be determined based on collected data including ambient temperature data and vehicle traction data. In some examples, hail may be determined as an environmental condition based on ambient temperature data, barometric pressure data, precipitation data, and/or weather data generally. In some examples, the vehicle may drive along a road with one or more suspension sensors in their normal driving configurations, and may collect suspension data indicating the operation of the vehicle's suspension as the vehicle travels along the road. The vehicle may drive over a pothole, and may determine that the pothole or similar defect exists in the road, at the location where the vehicle encountered the pothole, based on the suspension data that the vehicle collected. As another example, the vehicle may drive along a road with various sensors for detecting rain, to facilitate automatic operation of the vehicle's windshield wipers when rain is detected. The vehicle may collect data using the various sensors for detecting rain, to allow the vehicle to determine that rain is falling at the vehicle's location. As described herein, the vehicle may communicate the collected data and/or determination that rain is falling, with the associated location of the vehicle, to other vehicles, or to a database. As yet another example, the vehicle may be traveling along a road with various sensors configured to detect bright sunshine and facilitate automatic operation of one or more window shades of the vehicle. The vehicle may collect data using the various sensors for detecting bright sunshine and may determine that bright sunshine is an environmental condition at the vehicle's location, and may communicate or store the collected data or determination as described with reference to several examples herein.

FIG. 6 illustrates an exemplary process 600 for determining a vehicle's location according to examples of the disclosure. Process 600 can be performed continuously or repeatedly whenever information about the vehicle's location is needed, or whenever a change is detected in one or more environmental conditions associated with the vehicle's location. Alternatively or in addition, process 600 can be performed continuously or repeatedly by the vehicle whenever the vehicle travels a certain distance or at determined intervals of time. In some examples, process 600 can be performed to determine the vehicle's location in circumstances where the vehicle's location may be difficult or impossible to determine using other means of determining the vehicle's location (e.g., GPS).

At block 610, in some examples, the vehicle may collect data from various sensors on the vehicle (e.g., automotive sensors) that may normally be configured to facilitate one or more vehicle functions, such as described in this disclosure. In some examples, as will be described below, a vehicle's location may be determined based on an environmental condition determined at the vehicle, or based on data the vehicle collects, via one or more sensors normally configured to facilitate at least one vehicle function. For example, the vehicle may collect data from its suspension sensors as the vehicle drives along a road at block 610.

At block 620, in some examples, the vehicle may determine an environmental condition based on the data that it collected using its various sensors. For example, the vehicle may determine that it encountered a pothole or other defect in the road, of a specific size, based on data the vehicle collected from its suspension sensors.

At block 630, in some examples, the vehicle may compare the determined environmental condition with a predetermined environmental condition. For example, the vehicle may compare the determined environmental condition and the predetermined environmental condition based on the type of each environmental condition (e.g., rain, snow, temperature, road condition or pothole, ice, oil, incline, etc.). In some examples, the vehicle may compare the environmental conditions based on the data associated with each environmental condition. For example, the vehicle may compare the two determined potholes based on the depth and/or the area of each pothole indicated by the respective suspension data of each pothole. As another example, the vehicle may compare two patches of ice based on the periods of time over which the traction decreased and the extent of each decrease associated with each patch of ice. In some examples, the predetermined environmental condition can be stored in a weather map or otherwise associated with (e.g., located at) a location, as described in this disclosure.

At block 640, in some examples, the vehicle's location may be determined to be a respective location of the predetermined environmental condition, based on the comparison of the determined environmental condition and the predetermined environmental condition. In some examples, where the difference of the data of one or more determined environmental conditions and one or more predetermined environmental conditions is less than a threshold amount, the vehicle may determine its location to be the respective location associated with the one or more predetermined environmental conditions. For example, the vehicle may determine a difference of the area of two potholes (e.g., the determined pothole and the predetermined pothole) is less than a threshold amount, the vehicle may determine its location to be the respective location associated with the pothole of the predetermined environmental condition in a weather map. In some examples, the vehicle may compare several environmental conditions with several predetermined environmental conditions to determine that its location is a location associated with the several predetermined environmental conditions. For example, the vehicle may compare determined temperature, elevation, and road quality conditions with predetermined temperature, elevation and road quality conditions, respectively, stored in a weather map, and may determine its location to be the respective location of the predetermined conditions only where each of the comparisons is less than a threshold (e.g., individually or collectively).

In some examples, a vehicle's location may be determined based on a known environmental condition or based on an expected environmental condition. For example, an onboard computer of a vehicle may store a previously determined environmental condition with its respective location, and may later use the stored condition as a predetermined environmental condition with its respective location. Thus, the vehicle's location may be determined based on a comparison of a determined environmental condition and a predetermined environmental condition, where the vehicle's location is determined to be the predetermined environmental condition's respective location. For example, the vehicle may verify a location using the presence of an incline with an expected grade at an expected location. In this way, the vehicle can use data from its sensors and determined environmental conditions to determine its location.

Therefore, according to the above, some examples of the disclosure are directed to a method for generating a map of environmental conditions comprising: determining a location of a vehicle; collecting data using one or more automotive sensors on the vehicle, the vehicle configured to control its operation based on the collected data; determining at least one environmental condition based on the collected data; and communicating the determined at least one environmental condition to a database to generate the map of environmental conditions. Additionally or alternatively to one or more of the examples disclosed above, in some examples, the at least one environmental condition is indicative of one or more of ambient temperature, precipitation, weather, and road condition. Additionally or alternatively to one or more of the examples disclosed above, in some examples, the one or more automotive sensors include one or more of temperature sensors, rain sensors, cameras, vehicle stability control sensors, vehicle suspension sensors, humidity sensors, elevation sensors, incline sensors, and microphones. Additionally or alternatively to one or more of the examples disclosed above, in some examples, the map of environmental conditions comprises a real-time database of environmental conditions organized according to location. Additionally or alternatively to one or more of the examples disclosed above, in some examples, the at least one environmental condition communicated to the database is associated with the determined location of the vehicle. Additionally or alternatively to one or more of the examples disclosed above, in some examples, the generated map of environmental conditions comprises a real-time weather map. Additionally or alternatively to one or more of the examples disclosed above, in some examples, the map of environmental conditions is generated based on data collected by automotive sensors of a plurality of vehicles. Additionally or alternatively to one or more of the examples disclosed above, in some examples, the method further comprises determining a route for the vehicle based on the generated map of environmental conditions. Additionally or alternatively to one or more of the examples disclosed above, in some examples, controlling the operation of the vehicle based on the collected data includes one or more of automatically activating windshield wipers on the vehicle, initiating an autonomous driving maneuver of the vehicle, or modifying a route of the vehicle. Additionally or alternatively to one or more of the examples disclosed above, in some examples, the method further comprises controlling operation of the vehicle based on the collected data. Additionally or alternatively to one or more of the examples disclosed above, in some examples, determining the at least one environmental condition based on the collected data comprises: in accordance with a determination that the collected data satisfies first weather condition criteria, determining that the collected data corresponds to a first weather condition; and in accordance with a determination that the collected data satisfies second weather condition criteria, different from the first weather condition criteria, determining that the collected data corresponds to a second weather condition, different from the first weather condition.

Some examples of the disclosure are directed to a method for determining a location of a vehicle comprising: collecting data from one or more automotive sensors on the vehicle; determining an environmental condition at the vehicle based on the collected data; and determining the location of the vehicle to be a respective location based on a comparison of the environmental condition and a predetermined environmental condition associated with the respective location.

Some examples of the disclosure are directed to a non-transitory computer-readable medium including instructions, which when executed by one or more processors, cause the one or more processors to perform a method comprising: determining a location of a vehicle; collecting data using one or more automotive sensors on the vehicle, the vehicle configured to control its operation based on the collected data; determining at least one environmental condition based on the collected data; and communicating the determined at least one environmental condition to a database to generate the map of environmental conditions.

Some examples of the disclosure are directed to a non-transitory computer-readable medium including instructions, which when executed by one or more processors, cause the one or more processors to perform a method comprising: collecting data from one or more automotive sensors on a vehicle; determining an environmental condition at the vehicle based on the collected data; and determining a location of the vehicle to be a respective location based on a comparison of the environmental condition and a predetermined environmental condition associated with the respective location.

Some examples of the disclosure are directed to a vehicle comprising: one or more automotive sensors; one or more processors coupled to the automotive sensors, and configured to perform a method comprising: determining a location of the vehicle; collecting data using the one or more automotive sensors on the vehicle, the vehicle configured to control its operation based on the collected data; determining at least one environmental condition based on the collected data; and communicating the determined at least one environmental condition to a database to generate the map of environmental conditions.

Some examples of the disclosure are directed to a vehicle comprising: one or more automotive sensors; one or more processors coupled to the automotive sensors, and configured to perform a method comprising: collecting data from the one or more automotive sensors on the vehicle; determining an environmental condition at the vehicle based on the collected data; and determining a location of the vehicle to be a respective location based on a comparison of the environmental condition and a predetermined environmental condition associated with the respective location.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method for generating a map of environmental conditions comprising:
determining a location of a vehicle;
collecting data using one or more automotive sensors on the vehicle, the vehicle configured to control its operation based on the collected data;
determining at least one environmental condition based on the collected data; and
communicating the determined at least one environmental condition to a database to generate the map of environmental conditions.

2. The method of claim 1, wherein the at least one environmental condition is indicative of one or more of ambient temperature, precipitation, weather, and road condition.

3. The method of claim 1, wherein the one or more automotive sensors include one or more of temperature sensors, rain sensors, cameras, vehicle stability control sensors, vehicle suspension sensors, humidity sensors, elevation sensors, incline sensors, and microphones.

4. The method of claim 1, wherein the map of environmental conditions comprises a real-time database of environmental conditions organized according to location.

5. The method of claim 1, wherein the at least one environmental condition communicated to the database is associated with the determined location of the vehicle.

6. The method of claim 1, wherein the generated map of environmental conditions comprises a real-time weather map.

7. The method of claim 1, wherein the map of environmental conditions is generated based on data collected by automotive sensors of a plurality of vehicles.

8. The method of claim 1, further comprising determining a route for the vehicle based on the generated map of environmental conditions.

9. The method of claim 1, wherein controlling the operation of the vehicle based on the collected data includes one or more of automatically activating windshield wipers on the vehicle, initiating an autonomous driving maneuver of the vehicle, or modifying a route of the vehicle.

10. The method of claim 1, further comprising controlling operation of the vehicle based on the collected data.

11. The method of claim 1, wherein determining the at least one environmental condition based on the collected data comprises:
in accordance with a determination that the collected data satisfies first weather condition criteria, determining that the collected data corresponds to a first weather condition; and
in accordance with a determination that the collected data satisfies second weather condition criteria, different from the first weather condition criteria, determining that the collected data corresponds to a second weather condition, different from the first weather condition.

12. A non-transitory computer-readable medium including instructions, which when executed by one or more processors, cause the one or more processors to perform a method comprising:
determining a location of a vehicle;
collecting data using one or more automotive sensors on the vehicle, the vehicle configured to control its operation based on the collected data;
determining at least one environmental condition based on the collected data; and
communicating the determined at least one environmental condition to a database to generate the map of environmental conditions.

13. A vehicle comprising:
one or more automotive sensors;
one or more processors coupled to the automotive sensors, and configured to perform a method comprising:
collecting data from the one or more automotive sensors on the vehicle;
determining an environmental condition at the vehicle based on the collected data; and
determining a location of the vehicle to be a respective location based on a comparison of the environmental condition and a predetermined environmental condition associated with the respective location.

14. The vehicle of claim 13, wherein the environmental condition is generated based on data collected by automotive sensors of a plurality of vehicles.
